(19) United States
(12) Patent Application Publication
(10) Pub. No.: US 2026/0289661 A1
(43) Pub. Date: Sep. 24, 2026

(54) ENSEMBLE MACHINE LEARNING SYSTEM FOR DYNAMIC RESOURCE ALLOCATION USING CROSS-SOURCE DATA AGGREGATION

(71) Applicant: Fundbox Ltd, Tel Aviv (IL)

(72) Inventors: Kevin Hanbing Gong, San Francisco, CA (US); Sarvesh Baveja, San Francisco, CA (US); Kevin Donald Cory, Arlington, VA (US); Baodong Hu, New York, NY (US)

(73) Assignee: Fundbox Ltd, Tel Aviv (IL)

(21) Appl. No.: 19/083,855

(22) Filed: Mar. 19, 2025

(51) Int. Cl. G06Q 40/03; G06N 5/01

(52) U.S. Cl. CPC G06Q 40/03; G06N 5/01

(57) ABSTRACT

A computer-implemented method for evaluating resource allocation requests using an ensemble machine learning model is disclosed. A resource request is received, comprising multiple data inputs from different data sources, where each data source provides a specific type of user feature. A first set of machine learning models, each trained on a single data source, generates corresponding first risk scores. A second decision tree-based machine learning model processes the data inputs, leveraging feature dependencies and learned missing feature patterns to generate a second risk score, enabling robust predictions even when certain user features are incomplete or missing. The first and second risk scores are ensembled using an ensemble technique to produce an overall risk score. The ensembled risk score is then transmitted to a resource hosting device, which approves, denies, or adjusts the requested resource based on the assessed risk.

### TECHNICAL FIELD

The present disclosure relates to machine learning-based resource allocation systems, and more particularly, to an ensemble learning framework that dynamically integrates multiple machine learning models to optimize decision-making in scenarios where resource allocation requests involve heterogeneous and incomplete data sources.

### BACKGROUND

Many real-world systems rely on evaluating resource allocation requests before granting access to limited resources. These systems span various domains, including computational resource management, network bandwidth allocation, AI model instance provisioning, physical infrastructure scheduling, and financial resource distribution (e.g., loan approvals or fund allocations). In such environments, a requesting entity must submit various data inputs, which may originate from multiple data sources, such as historical usage records, financial data, security logs, or operational telemetry.

Traditional resource allocation systems rely on a fixed set of required information before evaluating a request. If any required data is missing, the request is delayed by asking for additional information or automatically rejected regardless of its legitimacy. While this ensures consistency, it also leads to bias and inefficiencies, preventing legitimate requests from being approved due to minor data gaps.

For example, a new business applying for a loan may lack a detailed credit history but could still demonstrate financial stability through alternative records. Similarly, a first-time user requesting cloud computing resources may not have prior usage logs but could still be a valid customer. Likewise, a network operator assessing bandwidth reservations may reject a new service provider simply due to a lack of historical traffic data, missing opportunities to secure high-value clients.

This rigid system that relies on complete data for every request struggles to handle dynamic and fast-changing conditions. In high-throughput environments, such as AI model provisioning, cloud resource allocation, network bandwidth management, or financial resource allocation (real-time loan applications), the inability to make timely decisions due to missing data reduces overall system efficiency. Existing approaches fail to balance risk management with decision speed, making it difficult to allocate resources optimally while still maintaining reliability and fairness in the decision-making process.

### SUMMARY

A system comprising one or more computers may be configured to perform specific operations or actions through the installation of software, firmware, hardware, or a combination thereof. These components, when in operation, cause the system to execute the required actions. Similarly, one or more computer programs may be designed to perform these operations by including instructions that, when executed by a data processing apparatus, enable the apparatus to carry out the specified actions.

In one general aspect, a computer-implemented method includes receiving a resource request from a user for a resource hosting device to allocate resources. The resource request includes multiple data inputs from various data sources, with each data source providing a particular type of user feature associated with the requesting user. The method further includes processing these data inputs using a first set of machine learning models to generate a set of first risk scores. Each machine learning model in this set is trained on user features from a single data source and generates a corresponding risk score based on the provided data.

Additionally, the method involves processing the same data inputs using a second machine learning model to generate a second risk score. The second model is a decision tree-based model trained on multiple types of user features, allowing it to recognize missing feature patterns across the various data sources. This capability enables the model to handle cases where one or more user features are incomplete or missing. The second model generates its risk score by analyzing feature dependencies within the data inputs. If any data inputs are incomplete or missing, the second model compensates for the missing information using learned feature dependencies rather than ignoring the missing data entirely.

Furthermore, the method includes ensembling the set of first risk scores and the second risk score to generate an ensembled risk score. The ensembled risk score integrates both single-source and cross-source risk evaluations to provide a more accurate and robust risk assessment. The ensembled risk score is then transmitted to the resource hosting device, which determines how to respond to the resource allocation request based on the ensembled score.

Other embodiments of this aspect include corresponding computer systems, apparatuses, and computer programs recorded on one or more computer storage devices, each configured to execute the actions described in the method.

In some implementations, the second model consists of multiple decision trees, and when certain data inputs are incomplete or missing, it dynamically adjusts its prediction pathways based on learned missing feature patterns. The first set of machine learning models corresponds to multiple data sources, with each model—including logistic regression models—trained specifically on features from its corresponding data source. If a data input from a particular source is missing, the logistic regression model associated with that source is deactivated.

The second model may be a LightGBM model, which uses gradient boosting to iteratively refine risk predictions. To handle missing data, the training of the second model assigns incomplete or missing user features to a separate splitting category during tree construction. This process allows the model to learn a default routing strategy for cases with null or unavailable inputs. The default routing strategy is updated at each training iteration based on loss-reduction criteria observed in training data that includes both complete and incomplete user features. Additionally, missing data can be managed by dynamically generating split thresholds for different user features. If a particular feature is unavailable, the second model automatically routes the request to the most appropriate decision tree node based on historical missing data patterns.

The ensembling process includes normalizing the first risk scores and the second risk score to a common scale. These normalized scores are then combined using confidence-based weighting, where each score's weight is adjusted according to the predictive confidence of its corresponding machine learning model. The ensembled risk score is generated by transforming the combined score into a probability format. The predictive confidence of each model is determined using performance metrics such as the Gini coefficient or area under the curve (AUC) scores. This confidence is dynamically adjusted in real time based on continuous monitoring of model performance.

The resource hosting device determines how to respond to the resource allocation request based on predefined risk thresholds. If the ensembled risk score exceeds a first threshold, the request may be rejected, and an alert may be sent requesting additional data. If the ensembled risk score surpasses a second, higher threshold, the system may classify the request as malicious and take security measures. This includes identifying a source address associated with the request—such as a user account identifier, device ID, or IP address—rejecting the request in real time, and blocking future requests from the same source. If the ensembled risk score falls below the first threshold, the requested resource is allocated to the user.

The type of resource being allocated may vary depending on the use case. The resource may include cloud computing resources, with the resource hosting device being a cloud-based infrastructure that manages virtual machine instances, GPU resources, or other computing resources. The resource hosting device decides whether to approve, deny, or modify the requested compute allocation based on the ensembled risk score, ensuring protection against malicious activity, excessive resource consumption, or inefficient utilization.

For network bandwidth allocation, the resource hosting device may be a network management system that reserves bandwidth for data transfers or streaming services. Based on the ensembled risk score, the system can approve, deny, or adjust bandwidth allocation to prevent fraud, excessive resource hoarding, or inefficient usage.

For AI model instances, the resource hosting device may be an AI infrastructure system responsible for deploying, fine-tuning, or executing AI models. Requests for AI inference, training, or experimentation may be approved, denied, or modified based on risk assessments that detect potential malicious activity, unauthorized usage, or excessive resource demands.

For financial resource allocation, such as loan funds, the resource hosting device may be a loan management system evaluating loan applications. The ensembled risk score determines whether to approve, deny, or adjust the requested loan amount based on factors such as credit risk, financial stability, or potential fraud.

Implementations of the described techniques may be realized in hardware, software, or as a combination of both. The system may include a computer-readable storage medium containing instructions that, when executed by a computing device, perform the resource allocation process as described.

In another general aspect, a system includes receiving a resource request from a user for a resource hosting device to allocate resources. The resource request contains multiple data inputs from various data sources, with each source providing specific user features relevant to the requesting user. The system processes these data inputs using a first set of machine learning models, each trained on a single data source, to generate corresponding risk scores. The system also processes the data inputs using a second machine learning model, which is a decision tree-based model trained on multiple types of user features. This second model learns missing feature patterns across various data sources, allowing it to handle cases where some user features are incomplete or missing.

The system then ensembles the first and second risk scores to produce a final ensembled risk score, which is used to determine how the resource hosting device responds to the allocation request. The response may involve approving, rejecting, or requesting additional information based on the ensembled risk score.

A non-transitory computer-readable storage medium may store instructions that, when executed, perform the above-described process. This includes receiving a resource request, processing data inputs through machine learning models, handling missing data intelligently, ensembling risk scores, and determining a response to the request. Other embodiments of this aspect include corresponding computer systems, apparatuses, and software programs stored on one or more storage devices, each configured to perform the described actions.

### BRIEF DESCRIPTION OF THE DRAWINGS

FIG. 1 illustrates a resource allocation framework utilizing cross-source data aggregation.

FIG. 2 illustrates homogeneous machine learning systems for risk evaluation in resource allocation use cases, in accordance with some embodiments.

FIG. 3 illustrates an exemplary heterogeneous machine learning system for risk evaluation in resource allocation use cases, in accordance with some embodiments.

FIG. 4 illustrates exemplary machine learning models in the heterogeneous machine learning system, in accordance with some embodiments.

FIG. 5 illustrates an exemplary process for ensembling risk scores generated from the heterogeneous machine learning models, in accordance with some embodiments.

FIG. 6 illustrates an example resource allocation process using the heterogeneous machine learning system, in accordance with some embodiments.

FIG. 7 illustrates an exemplary method for allocating resources using a heterogeneous machine learning system, in accordance with some embodiments.

FIG. 8 illustrates an example computing device in which any of the embodiments described herein may be implemented.

### DETAILED DESCRIPTION

The description is presented to enable any person skilled in the art to make and use the embodiments and is provided in the context of a particular application and its requirements. Various modifications to the disclosed embodiments will be readily apparent to those skilled in the art, and the general principles defined herein may be applied to other embodiments and applications without departing from the spirit and scope of the present specification. Thus, the specification is not limited to the embodiments shown but is to be accorded the widest scope consistent with the principles and features disclosed herein.

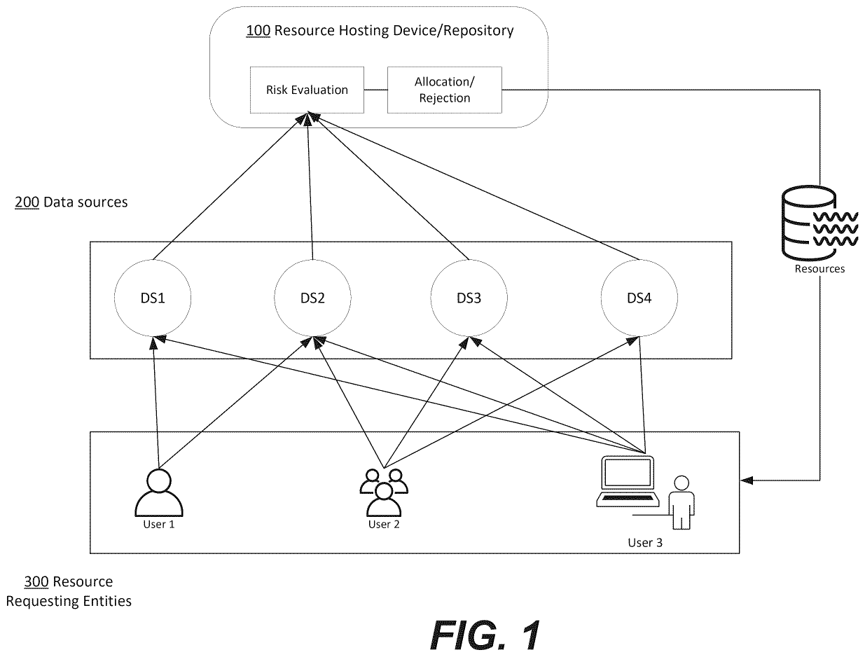

FIG. 1 illustrates a resource allocation framework utilizing cross-source data aggregation. The framework includes a resource hosting device or repository 100, a set of data sources 200, and multiple resource requesting entities 300. Each resource requesting entity 300, such as User 1, User 2, or User 3, submits a request for resources by providing data inputs from the data sources 200 to the resource hosting device or repository 100. These data inputs represent the entity's feature data, also referred to as user features, which characterize the entity's attributes relevant to the resource allocation decision.

The resource hosting device or repository 100 processes each resource request by analyzing the submitted user features and computing a risk score associated with the request. The risk score serves as an indicator of potential issues such as malicious intent, fraudulent activity, or high default risk. Based on the computed risk score, the resource hosting device or repository 100 may either approve the request and proceed with resource allocation or deny the request, potentially triggering additional security measures or manual review processes.

However, not all requesting entities 300 have data available from every data source 200. As depicted in FIG. 1, User 3 provides data inputs from all available data sources 200, enabling the resource hosting device or repository 100 to perform risk evaluation with a complete feature set. In contrast, User 1 and User 2 only provide partial data, as certain data sources 200 are unavailable for them.

Traditional resource allocation systems often adopt a rigid approach to handling incomplete data. Some may automatically reject requests with missing data, while others may ignore missing data entirely when calculating risk scores, and predict the risk solely based on the available data. However, simply disregarding missing data without considering interdependencies and relationships between different data sources leads to inaccurate risk predictions and suboptimal decision-making.

To address these challenges, the following description introduces an ensemble machine learning system for dynamic resource allocation. The system employs heterogeneous machine learning models that evaluate data inputs from multiple perspectives (intra-data source and cross-data source) and learn missing data patterns based on historical correlations across data sources. By incorporating informed handling of missing data, the system produces more accurate and reliable risk predictions, enabling better resource allocation decisions even when complete data is unavailable.

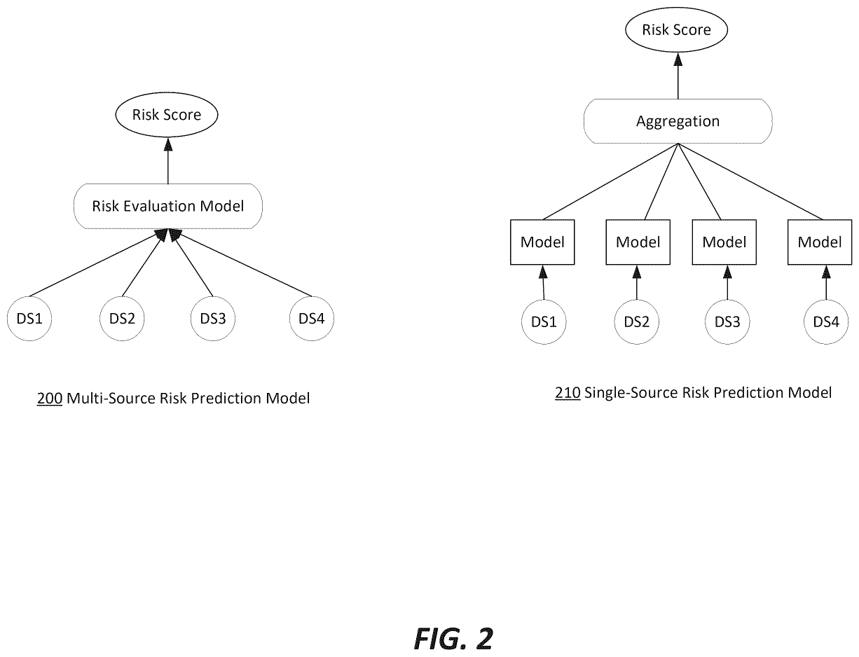

FIG. 2 illustrates homogeneous machine learning systems for risk evaluation in resource allocation use cases, in accordance with some embodiments. FIG. 2 depicts two distinct homogeneous machine learning approaches that were tested by the inventors to assess their effectiveness in predicting risk scores based on available data sources.

The first homogeneous machine learning system is a cross-source risk prediction model 200, which may be implemented as a neural network (e.g., a convolutional neural network (CNN)), a deep learning model, a tree-based model, or another suitable machine learning model. This model 200 is trained using historical data from multiple data sources to generate risk scores. The predicted risk scores are compared with ground truth labels associated with historical data to determine prediction errors, and the model parameters are adjusted to minimize these errors. Because the model 200 learns from all available data sources simultaneously, it inherently focuses on capturing cross-source relationships and global risk patterns, making predictions from the perspective of data breadth rather than focusing on individual data sources.

The second homogeneous machine learning system consists of multiple single-source risk prediction models 210. Each model 210 is trained independently using historical data from a single data source along with its corresponding risk labels. As a result, each model 210 specializes in capturing the latent relationships between the features within its respective data source and the specific risk factors indicated by that data source. After generating individual risk scores, the outputs of all models 210 may be aggregated to compute a final risk score, combining the independent assessments of each single-source model.

While both homogeneous approaches offer advantages, each comes with significant limitations. In the cross-source model 200, a single feature embedding layer is typically used to process all types of user features uniformly. Because different data sources capture distinct aspects of user behavior, treating them identically in a single embedding or feature representation can dilute source-specific signals. In other words, the model 200 may struggle to accurately capture the unique nuances of each data source, leading to suboptimal predictions or reduced interpretability. Another downside of the cross-source model is the increased number of features, which often requires larger, more complex models to capture signals effectively. However, these larger models are more susceptible to overfitting, leading to decreased performance. Additionally, they are less explainable, potentially posing regulatory challenges, increasing drift or degradation over time.

Meanwhile, the single-source models 210, although capable of specializing in data from a single source, fail to capture cross-source interactions or synergy between different data types, yielding a fragmented view of the overall risk. These shortcomings underscore the need for a heterogeneous machine learning system that unifies the strengths of both approaches—respecting each data source's unique contribution while also leveraging the combined insights across data sources—to deliver more accurate and context-aware risk evaluations.

The inventors found that neither the model 210 nor the model 200 achieves optimal prediction accuracy, particularly when a resource requesting entity has missing or incomplete data. To harvest the advantages of both models, the inventors designed a heterogeneous machine learning system, which intelligently integrates single-source learning with cross-source feature interactions, ensuring more accurate, flexible, and reliable risk evaluation even in the presence of missing data.

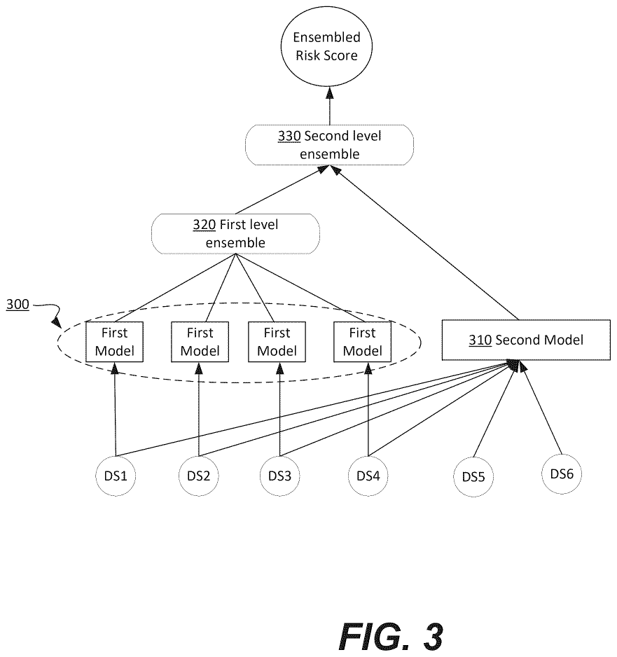

FIG. 3 illustrates an exemplary heterogeneous machine learning system for risk evaluation in resource allocation use cases, in accordance with some embodiments. Unlike the homogeneous machine learning systems described in FIG. 2, which rely solely on either cross-source or single-source models, the heterogeneous system in FIG. 3 integrates both single-source and cross-source machine learning models to improve prediction accuracy, particularly when handling incomplete or missing data.

The heterogeneous machine learning system in FIG. 3 includes a first set of machine learning models 300 and a second machine learning model 310. The first set of machine learning models 300 comprises single-source models, each of which is trained exclusively on historical data from a single data source. Each model 300 focuses on learning latent relationships between the user features from its corresponding data source and the overall risk score, without considering interactions with other data sources. Meanwhile, the second model 310 is a cross-source model, trained on all types of user features from all available data sources. This model captures cross-source feature dependencies and learns patterns associated with missing features, enabling it to handle cases where certain user features are incomplete or entirely absent from the data inputs.

When a resource allocation request is received from a user, the request includes data inputs from one or more data sources. If data from a particular data source is available, it is processed by the corresponding single-source model 300, which generates a source-specific risk score. Conversely, if data from a specific source is missing, the associated single-source model 300 remains inactive, and no risk score is generated for that source. The system allows parallel processing of data inputs from multiple sources, enabling the simultaneous computation of multiple source-specific risk scores based on the available user-provided data.

In addition to evaluating individual data sources, the entire set of available data inputs—regardless of completeness—is processed by the second machine learning model 310. This multi-source model generates a cross-source risk score by analyzing feature dependencies across different data sources and dynamically handling missing features.

In some embodiments, the source-specific risk scores generated by the first set of machine learning models 300 are first ensembled in a first-level ensembling process 320. The resulting ensembled score is then combined with the cross-source risk score generated by the second model 310 in a second-level aggregation process 330. In alternative embodiments, all risk scores—including those from the single-source models and the cross-source model—are ensembled simultaneously in a unified ensembling process. The ensembled risk score may be provided to the downstream system (e.g., the resource hosting device or repository) to determine a response to the resource application request accordingly.

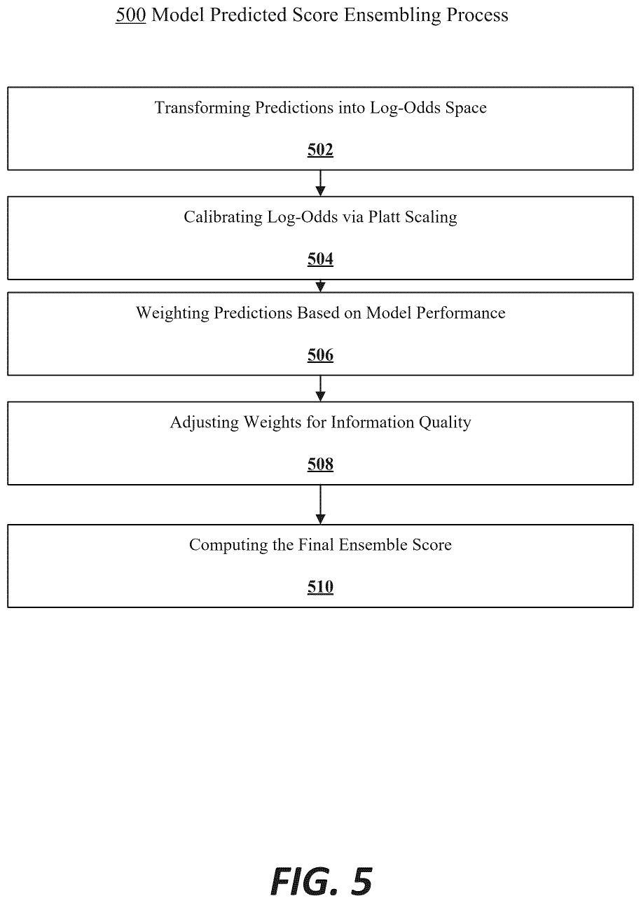

Ensembling the risk scores from single-source models 300 and cross-source models 310 presents several technical challenges that extend beyond commonly used weighted sum or average. The predictive power of each model can vary over time or across different segments of users, making a static weighting scheme insufficient. In addition, the presence of missing or incomplete data can skew certain models or reduce overall accuracy, further complicating a straightforward aggregation. Moreover, each model operates with its own probability scale, often trained on distinct distributions of data and carrying unique biases. FIG. 5 will describe an example process for addressing these challenges and unifying the outputs of single-source and cross-source risk prediction models into a single coherent score.

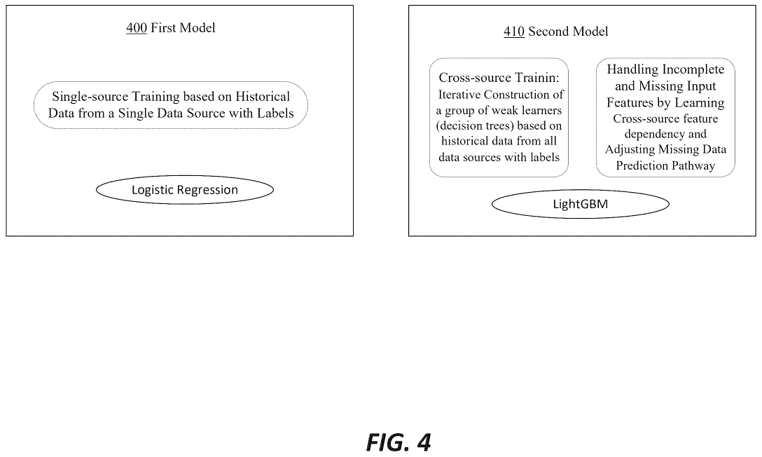

FIG. 4 illustrates exemplary machine learning models deployed in the heterogeneous machine learning system, in accordance with some embodiments. The system in FIG. 4 shows a first model 400, which represents a single-source machine learning model, and a second model 410, which represents a cross-source machine learning model.

The first model 400 corresponds to the single-source machine learning models 300 described in FIG. 3. Each instance of the first model 400 is trained independently on historical data obtained from a specific data source, without considering cross-source dependencies. This training process involves input features solely derived from the respective data source, along with corresponding ground truth labels that indicate risk (e.g., fraud likelihood, default probability, or security threat level that are generated based on the outcome of the resource allocation).

An exemplary implementation of the first model 400 is a logistic regression model. Logistic regression model offers interpretable linear decision boundary and robust performance in single-source prediction scenarios. The logistic regression model maps input features from a single data source into a probability score that quantifies the likelihood of a negative outcome (e.g., fraudulent request, high-risk transaction). Each logistic regression model is optimized by adjusting its weight coefficients to minimize a classification error, such as log-loss, using gradient-based optimization methods.

For example, in a specific resource allocation scenario (e.g., cloud computing resource, or financial loan), the requesting entity's historical data from a financial institution (FI) may be used to train a logistic regression model that evaluates the risk of non-payment. The training data includes past resource requests where the input features comprise financial attributes such as account balance trends, payment history, and transaction frequency (e.g., all from the same data source FI). Each historical request is labeled based on whether the user defaulted on payments or successfully paid for allocated resources. During training, the logistic regression model learns correlations between these financial features and the likelihood of default. By adjusting its weight coefficients to minimize classification errors, the trained model can later evaluate incoming resource requests based solely on FI data and generate a probability score indicating the risk of non-payment.

Since each single-source model is independently trained, it excels at learning data patterns unique to its respective data source. However, it does not capture interdependencies across data sources, which can lead to incomplete or suboptimal risk assessment when the available data is sparse or fragmented. The first model 400 is used to extract domain-specific risk indicators, which are then combined with broader cross-source risk assessments in the heterogeneous system.

The second model 410 corresponds to the cross-source machine learning model 310 described in FIG. 3. Unlike the first model 400, which operates on data from a single source, the second model 410 is trained on data aggregated from multiple sources, allowing it to learn cross-source feature dependencies and handle missing data patterns dynamically.

In some embodiments, the second model 410 is a decision tree-based model that builds an ensemble of weak decision trees to iteratively enhance risk prediction accuracy. For example, the second model 410 may utilize a gradient boosting framework, such as LightGBM. LightGBM constructs a sequence of decision trees, where each successive tree is trained to correct the errors of the previous ones. This iterative refinement process enables the model to dynamically adjust decision thresholds and feature splits, improving predictive performance and capturing complex, non-linear relationships within the data.

In some embodiments, the second model 410 is trained using historical records that span multiple data sources, allowing it to capture interactions between different user features. Unlike models that process each data source in isolation, the second model 410 learns cross-source feature dependencies, such as correlations between financial records and prior resource usage patterns. Since the importance of different user features varies across users and specific contexts, the second model 410 does not treat all features equally but rather learns which combinations of data points provide the most reliable indicators of risk.

A critical advantage of incorporating the second model 410 in the system is its ability to handle incomplete or missing data, a common challenge in real-world resource allocation scenarios. Traditional models often either completely ignore missing data, leading to incomplete evaluations, or reject requests outright, which can result in missed opportunities for legitimate applicants. In contrast, the second model 410 incorporates missing data patterns into its learning process. During training, if a data source is unavailable for a given training sample, the second model 410 assigns the missing features to a separate splitting category (i.e., a predictive pathway in a LightGBM model), effectively learning a default routing strategy for cases where inputs are incomplete. This ensures that the second model 410 can make informed decisions even when some expected data is absent. Rather than treating missing data as a gap in the evaluation, the second model 410 recognizes it as a meaningful signal and adjusts its predictions accordingly.

At inference time, the second model 410 dynamically adjusts prediction pathways in the decision trees by routing the requests with missing data to the appropriate decision tree nodes and branches based on historical patterns of missing values. Instead of arbitrarily filling in missing data or disregarding it altogether, the second model 410 uses its learned missing data patterns to infer the best-fit prediction pathway.

In a specific example, the second model 410 is exposed during training to historical data containing a mixture of complete and incomplete feature sets across multiple data sources. Some training samples may lack certain types of user features entirely—for instance, a user may have financial transaction records (Type B) and demographic details (Type C) but no credit history data (Type A). Rather than discarding these incomplete samples or imputing default values, the second model 410 assigns missing features to a separate splitting category within the decision tree structure. That is, the second model 410 learns how users with missing Type A data behave in comparison to users with complete data and to recognize patterns in how other available features (Types B and C) correlate with risk outcomes in the absence of Type A data.

At inference time, when a new resource request is received, the second model 410 evaluates whether all required feature types are present. If a specific user feature (e.g., Type A) is missing, the model does not simply ignore it or assume a worst-case scenario. Instead, it dynamically reroutes the evaluation pathway based on learned missing-data patterns from the training phase. For example, if past training data indicated that users missing Type A features but exhibiting stable and growing revenue in Type B and long operational history in Type C tend to fall within a moderate-risk category, the second model 410 will adjust its decision path accordingly. Conversely, if the absence of Type A features historically coincided with erratic financial behavior in Type B, the model may infer a higher-risk profile. This ensures that the prediction is made in an informed manner, rather than relying on rigid, predefined assumptions about missing data.

FIG. 5 illustrates an exemplary process 500 for ensembling risk scores generated from the heterogeneous machine learning models, in accordance with some embodiments. The ensembling process 500 addresses the technical challenges of aligning distinct probability scales, accommodating varying predictive power over time, and managing missing or incomplete data. In some embodiments, the ensembling process 500 includes the following steps.

Step 502: Transforming Predictions into a Log-Odds Space

As shown, the ensembling process 500 may begin with normalizing the risk scores produced by the first set of single-source models and the second cross-source model onto a common scale. Each of the first risk scores and the second risk score is converted into log-odds space using a logit function. This transformation linearizes the relationship between risk scores and probability, ensuring that changes near the extremes (close to 0 or 1) receive appropriate weight. Without this, small changes in probability near 0.5 might be treated similarly to changes near the extremes, leading to biased decisions.

### Step 504: Calibrating Log-Odds via Platt Scaling

Following the log-odds transformation, a calibration step may be performed. For example, Platt scaling may be used to adjust the log-odds values to maintain proper rank ordering and compensate for biases caused by differences in the training populations of each model. This calibration process may assure that the final ensembled score is not unfairly dominated or diluted by any single model's inherent probability scaling, thereby aligning all models into a shared risk evaluation framework.

### Step 506: Weighting Predictions Based on Model Performance (Predictive Confidence)

After normalization and calibration, the system applies confidence-based weighting to each model's contribution to the ensembled score. The weight assigned to each model is dynamically determined based on its predictive confidence, which is derived from model performance metrics such as the Gini coefficient or area under the curve (AUC) scores. Models that demonstrate stronger predictive accuracy in differentiating between high-risk and low-risk cases receive higher weights, while weaker models receive lower influence in the aggregation process. In some embodiments, the weighting function may utilize the inverse hyperbolic tangent of the Gini score, as this approach effectively magnifies improvements at the upper end of the Gini scale, ensuring that higher-performing models contribute more significantly to the final prediction.

In some embodiments, the predictive confidence of the models may be computed based on one or more factors, including historical model performance metrics and the model's own self-reported confidence. For instance, the system can track how each model's predicted risk scores compare to the actual outcomes observed over a past time window—such as the default rate of monthly payments for the past several months or years—and assign higher weights to models whose predictions most closely match the ground truth. Models that consistently differentiate high-risk from low-risk cases receive higher weights, whereas underperforming models are given lower influence in the aggregation.

Additionally or alternatively, each model may generate its own indicator of predictive confidence; for example, a logistic regression model could produce confidence intervals or p-values associated with its parameter estimates, while a LightGBM model might report internal metrics such as feature importance or local prediction variance. Based on these real-time confidence measures, the system identifies which models are performing reliably under current conditions, and adjusts the confidence-weights of the models in real-time.

### Step 508: Adjusting Weights for Information Quality

In some embodiments, the predictive confidence of each machine learning model may also be adjusted in real time based on real-time performance monitoring and information quality assessments. For example, if a model's predictive accuracy degrades due to shifts in data patterns, its weighting can be reduced dynamically, preventing outdated or less reliable models from distorting the ensembled risk score. Furthermore, if a model is trained on data that is known to be incomplete or outdated for a specific request, its contribution to the final ensemble can be reduced accordingly to minimize bias introduced by stale information.

### Step 510: Computing the Final Ensemble Score

Because some of the first machine learning models rely on features that may not always be available, the ensembling process is designed to adapt dynamically to different data availability scenarios. If a specific data source is missing for a given request, the corresponding single-source model's contribution to the ensemble is automatically adjusted. This may involve reducing the weight of the model with missing data or excluding its contribution entirely, ensuring that predictions are not skewed by the absence of specific feature sets. Additionally, because the second model is trained to handle missing data by learning missing feature patterns across multiple data sources, its risk score inherently adjusts for gaps in input data. This prevents the system from making uninformed decisions based solely on missing information. The ensemble risk score is computed based on the weighted contributions of all participating models.

After confidence-based weighting is applied, the ensembled score is generated by aggregating the weighted log-odds values of all contributing models. The final ensembled risk score is then converted back into a probability format, e.g., using a sigmoid function, ensuring that the score remains interpretable as a probability value for downstream resource allocation decisions.

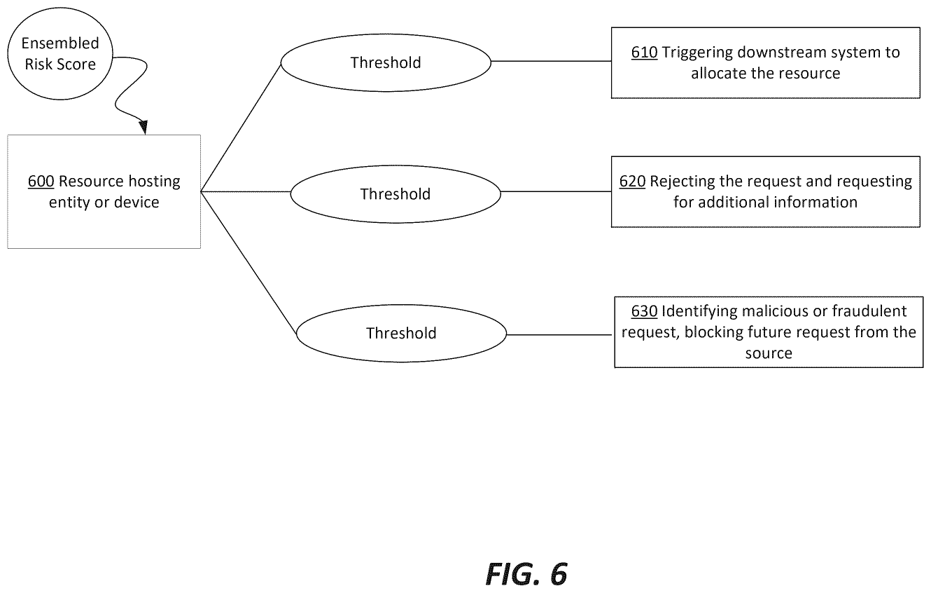

FIG. 6 illustrates an example resource allocation process using the heterogeneous machine learning system, in accordance with some embodiments. The process shows how a resource hosting entity or device 600—which may be a cloud computing service provider (e.g., cloud-based storage, cloud-based computing resources, cloud-based AI instances), a financial institution evaluating loan applications, or a network bandwidth management system—determines whether to approve, reject, or further assess a resource allocation request based on the ensembled risk score.

As described in FIGS. 3-5, when a resource allocation request is received, the heterogeneous machine learning system evaluates the request using single-source models and a multi-source model, generating risk scores that are ensembled into a final ensembled risk score. The resource hosting device 600 then compares the ensembled risk score against one or more predefined thresholds to determine an appropriate response.

In some embodiments, if the ensembled risk score exceeds a first threshold (610), the resource allocation request is rejected, and an alert is generated, requesting the user to provide additional supporting data to reassess eligibility.

In some embodiments, if the ensembled risk score exceeds a second threshold (630), the system identifies the request as malicious. The second threshold may be used independently or in conjunction with the first threshold and is generally set at a higher level (e.g., indicating a greater likelihood of fraud, abuse, or default).

Upon determining that a request is malicious, the resource hosting device 600 identifies a source address associated with the request, which may include a user account identifier, device identifier, IP address, or other user-related identifiers. The system then rejects the request in real time, preventing the resource from being allocated to a potentially harmful entity.

Beyond immediate rejection, the system may enforce preventive security measures by dynamically blocking future requests from the identified source address. This blocking mechanism ensures that repeated attempts from the same source cannot bypass the system's defenses.

This real-time blocking mechanism has significant technical implications in managing limited resources effectively. By proactively identifying and neutralizing high-risk requests, the system helps preserve service availability, ensuring that legitimate users retain access to the resources. In distributed financial or transactional systems, this approach is particularly critical for mitigating denial-of-service (DOS) attacks that could otherwise deplete shared computational or network resources.

In some embodiments, if the ensembled risk score falls below the first threshold (610), the system approves the request and proceeds with resource allocation. For example, the downstream system may be triggered to allocate the requested resource.

### Practical Application—Financial Resource Allocation

In a loan management system, users submit loan requests that must be evaluated for creditworthiness, financial stability, and fraud risk before loan amounts are allocated. Traditional credit evaluation methods rely on predefined criteria and may reject applications outright if certain required financial data is missing.

For example, upon receiving a loan request, the system processes multiple data inputs related to the applicant's financial status, including credit reports, banking transactions, small business financial exchange (SBFE) data, firmographic details, and historical repayment behavior. The first set of machine learning models, trained on single-source data, independently evaluates risk factors from each data source. For instance, a logistic regression model trained on credit report data may estimate default probability based on credit history, while another model analyzing bank transaction data may assess cash flow stability.

Simultaneously, the second machine learning model, a decision tree-based model, evaluates cross-source feature dependencies and compensates for missing data. If an applicant lacks credit report data, for example, the model can infer risk based on alternative data sources, such as income trends and business financial records. By learning historical patterns of default associated with missing data scenarios, the system ensures that applicants without traditional credit histories are not unfairly excluded while still maintaining strong risk controls.

The risk scores generated by the first and second machine learning models are ensembled using a structured aggregation framework. The system applies normalization and confidence-based weighting to ensure that models with higher predictive performance, as determined by real-time monitoring metrics such as Gini coefficients or AUC scores, contribute more significantly to the final risk assessment.

If the ensembled risk score falls below a predefined threshold, the loan is approved, and funds are allocated immediately. If the risk score is above a moderate threshold, the system may adjust the loan amount, shorten the repayment period, or require additional documentation for verification. If the ensembled risk score exceeds a high-risk threshold, the loan request is denied, and additional security measures may be triggered, such as fraud detection alerts, blocking future requests from the requesting device or account, or further review by a human underwriter.

### Practical Application—Artificial Intelligence (AI) Resource Allocation

In an AI infrastructure system, users—including developers, research teams, or external clients—submit requests for AI model instances to perform tasks such as inference, fine-tuning, or large-scale training. Since AI model execution requires significant computational resources, including GPU and TPU instances, memory, and storage, efficient allocation is critical to preventing resource waste, unauthorized use, or malicious activities such as spam generation. The resource hosting device evaluates each request in real time to determine whether to approve, deny, or modify the requested AI model instance allocation.

Upon receiving a request for AI model deployment, the system processes multiple data inputs related to the requesting entity. These inputs may include past model usage history, billing records, compliance verification, security logs, and prior incidents of resource misuse. The first set of machine learning models, trained on single-source data, individually evaluates specific aspects of the request. For instance, a logistic regression model analyzing past billing data may assess payment reliability, while another model trained on infrastructure logs may identify patterns of excessive or anomalous resource consumption.

Simultaneously, the second machine learning model, a decision tree-based model, processes all available data to learn cross-source feature dependencies and handle missing data. If certain inputs are unavailable, such as prior usage history for a new user, the model compensates by leveraging known patterns in related features (e.g., correlating account profile data with expected usage behavior). This enables the AI infrastructure system to maintain informed decision-making even when dealing with incomplete data.

The risk scores generated by the first and second machine learning models are then ensembled using a structured aggregation framework. The system applies normalization and confidence-based weighting to ensure that the ensembled risk score accurately reflects the reliability of the predictions. Models with higher predictive performance, as measured by real-time monitoring metrics such as Gini coefficients or AUC scores, contribute more significantly to the final risk assessment.

If the ensembled risk score falls below a defined threshold, the requested AI model instance is allocated without restriction. If the score is above a moderate threshold, the system may modify the allocation by applying rate limits, restricting access to certain model functions, or requiring additional verification from the user. If the risk score surpasses a high-risk threshold, the request is denied outright, and security measures such as request logging, user monitoring, or account suspension may be triggered to prevent repeated unauthorized attempts.

### Practical Application—Cloud Computing Resource Allocation

In a cloud computing environment, users frequently submit resource allocation requests for virtual machines, GPU instances, or other compute resources. These requests originate from various users, including developers, enterprises, and research institutions, each with different computing needs and risk profiles. The cloud-based infrastructure must evaluate these requests in real-time to determine whether they should be approved, denied, or modified to prevent resource abuse, unauthorized usage, or inefficient allocation.

When a resource allocation request is received, the system processes multiple data inputs associated with the requesting user, such as historical usage patterns, payment history, compute resource consumption trends, security flags, and authentication records. These data inputs are sourced from multiple data repositories, including cloud activity logs, billing records, and security analytics. The first set of machine learning models, which are single-source models, individually assess different dimensions of risk. For example, a logistic regression model trained on billing data may predict the likelihood of payment default, while another model trained on past compute usage may assess whether the requested resources align with prior usage patterns.

Simultaneously, the second machine learning model, a decision tree-based model, processes all available data inputs to capture cross-source feature dependencies and handle missing data scenarios. This model dynamically learns relationships between different types of user attributes, such as the correlation between security anomalies and prior resource consumption. If certain data inputs are missing—such as incomplete billing history for a new user—the model applies learned missing feature patterns to adjust the prediction pathway instead of ignoring the missing data outright.

The individual risk scores generated by the single-source models and the multi-source model are then ensembled using a structured aggregation framework. The ensembled risk score is normalized and weighted according to the predictive confidence of each model, which may be dynamically adjusted based on recent model performance. The final ensembled risk score quantifies the risk associated with the requested compute resources, allowing the cloud-based infrastructure to determine an appropriate response.

If the ensembled risk score falls below a predefined threshold, the cloud infrastructure approves the request and provisions the requested compute resources. If the risk score exceeds a moderate threshold, the system may modify the allocation by restricting the number of virtual machines or requiring additional verification before provisioning. In cases where the ensembled risk score exceeds a high-risk threshold, the system classifies the request as potentially malicious or indicative of excessive resource consumption. In such instances, the request is denied, and security mechanisms may be triggered, such as blocking further requests from the same user or requiring manual review.

### Practical Application—Network Bandwidth Resource Allocation

In a network infrastructure system, clients request reserved bandwidth for activities such as high-definition video streaming, large data transfers, or enterprise-level communication. Efficient bandwidth allocation is critical to maintaining service quality while preventing congestion, abuse, or fraudulent usage. The resource hosting device evaluates each request in real-time to determine whether it should be approved, denied, or modified to ensure optimal network utilization.

Upon receiving a bandwidth allocation request, the system processes multiple data inputs related to the requesting entity, including historical bandwidth usage, payment reliability, network anomaly detection, and past incidents of excessive consumption. These data inputs originate from different sources, such as billing systems, network traffic logs, and security monitoring services. The first set of machine learning models, each trained on data from a single source, generates independent risk scores assessing different aspects of the request. For example, a logistic regression model trained on prior billing data may estimate the likelihood of non-payment, while another model trained on traffic logs may detect unusual consumption patterns indicative of abuse.

In parallel, the second machine learning model, a decision tree-based model, processes all available data to learn feature dependencies across sources and handle missing data. If certain data points are unavailable—such as missing prior network history for a new client—the model leverages learned missing feature patterns to infer risk rather than ignoring the gap outright.

The individual risk scores from the single-source models and the multi-source model are then ensembled using a structured aggregation framework. The ensembled risk score is calibrated, weighted, and normalized based on predictive confidence, ensuring that decisions reflect the most reliable and current risk assessments.

If the ensembled risk score falls below a predefined threshold, the network infrastructure system grants the requested bandwidth allocation. If the score exceeds a moderate threshold, the system may modify the allocation, such as capping bandwidth limits or introducing additional verification steps. If the risk score surpasses a high-risk threshold, the request is denied, and security measures may be activated, including flagging the requesting entity for further monitoring or blocking future bandwidth reservations.

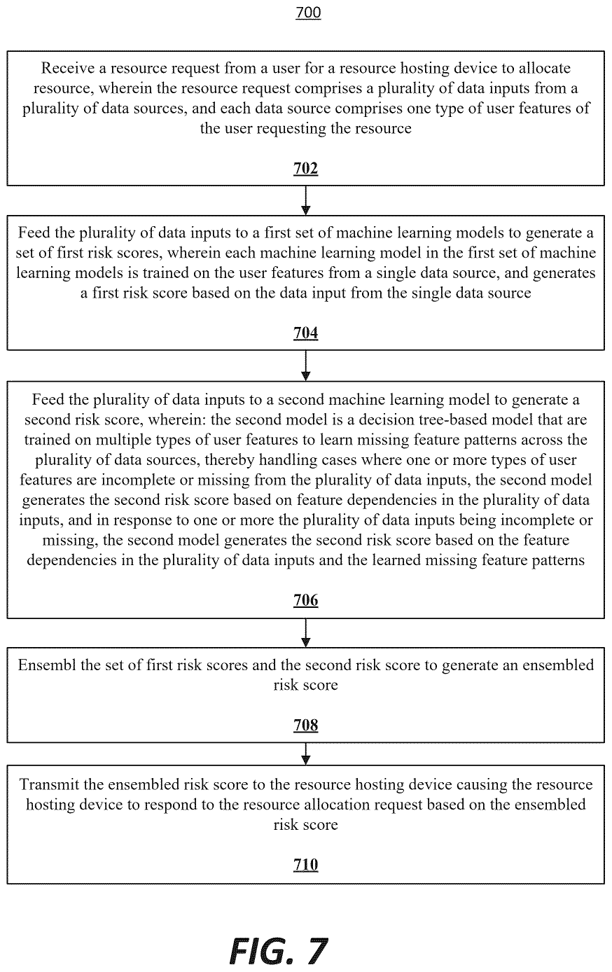

FIG. 7 illustrates an exemplary method for allocating resources using a heterogeneous machine learning system, in accordance with some embodiments. In some embodiments, one or more process blocks of FIG. 7 may be performed by a computing device.

As shown in FIG. 7, process 700 begins with receiving a resource allocation request from a user for a resource hosting device to allocate resources (702). The resource request includes multiple data inputs from various data sources, with each data source providing a specific type of user feature related to the requesting user. For example, a computing device may receive such a resource request, where the request includes different data inputs from various sources, as previously described.

Next, process 700 involves feeding the data inputs into a first set of machine learning models to generate a set of first risk scores (704). Each model in this first set is trained on user features from a single data source and produces a risk score based on that data. For instance, the device processes the provided inputs through these models, each of which is specialized in a specific data source, as previously detailed.

Process 700 then includes feeding the same data inputs into a second machine learning model to generate a second risk score (706). The second model is a decision tree-based model trained on multiple types of user features, allowing it to learn missing feature patterns across different data sources. This enables it to handle cases where one or more user features are incomplete or missing. The second model generates its risk score by analyzing dependencies between features across multiple data inputs. If certain features are missing, the model leverages learned patterns to infer an appropriate risk score rather than ignoring the missing data entirely.

Following this, process 700 performs an ensembling operation, combining the first risk scores from the single-source models with the second risk score from the multi-source model to generate an ensembled risk score (708). The device applies an ensembling technique to integrate these scores into a single risk evaluation.

Finally, process 700 includes transmitting the ensembled risk score to the resource hosting device (710), which determines a response to the resource request based on the ensembled score. The response may involve approving, denying, or requesting further information based on the ensembled risk assessment.

Process 700 may include additional implementations, which may be executed independently or in combination with other described implementations. In some embodiments, the second model consists of multiple decision trees, and when data inputs are incomplete or missing, the model dynamically adjusts its prediction pathways based on learned missing feature patterns. In another implementation, the first set of machine learning models corresponds to multiple data sources, and each model may include a logistic regression model trained specifically on features from its corresponding data source. If a data input from one of the data sources is missing or empty, the logistic regression model associated with that source is deactivated.

In some embodiments, the second model may be a LightGBM model, which refines risk predictions iteratively using gradient boosting. To process missing data, the second model may assign incomplete or missing features to a separate category during decision tree construction, allowing it to learn a default routing strategy for instances with missing inputs. The model updates this default direction iteratively based on loss-reduction criteria observed in training data that includes both complete and incomplete user features. Alternatively, missing data may be handled by dynamically generating split thresholds for user features. When certain features are unavailable, the model routes the request to the best-fit decision tree node based on historical missing data patterns.

The ensembling process itself includes several steps. First, the system normalizes the first risk scores and the second risk score to a common scale. Next, the normalized scores are combined using confidence-based weighting, where the weight for each score is adjusted based on the predictive confidence of the respective model. Finally, the ensembled risk score is generated by transforming the combined score into a probability format. The predictive confidence of each model may be determined using metrics such as the Gini coefficient or area under the curve (AUC) scores. This confidence may also be adjusted in real time based on continuous monitoring of model performance.

The response to the resource allocation request is determined based on predefined thresholds. If the ensembled risk score exceeds a first threshold, the request may be rejected, and an alert may be sent requesting additional data. If the ensembled risk score exceeds a second, higher threshold, the system may classify the request as malicious, identifying a source address associated with the request, such as a user account identifier, device ID, or IP address. The system may then reject the request in real time and block future requests from the same source. If the ensembled risk score falls below the first threshold, the requested resource may be allocated.

Depending on the use case, the resource being allocated may include cloud computing resources, network bandwidth, AI model instances, or loan funds. For cloud computing resources, the resource hosting device may be a cloud-based infrastructure allocating virtual machines, GPU resources, or other computing resources. The decision to approve, deny, or modify the allocation is based on the ensembled risk score, preventing unauthorized access, excessive resource consumption, or inefficient utilization. For network bandwidth, the resource hosting device may be a network management system that allocates reserved bandwidth for data transfers or streaming. Based on the ensembled risk score, the system may approve, deny, or adjust the bandwidth allocation to prevent fraud, resource hoarding, or inefficient use. For AI model instances, the resource hosting device may be an AI infrastructure system managing model deployments. Requests for AI inference, fine-tuning, or experimentation may be approved, denied, or modified based on risk assessments indicating potential malicious activity, unauthorized usage, or excessive resource demands. For loan funds, the resource hosting device may be a loan management system evaluating loan applications. The ensembled risk score determines whether to approve, deny, or adjust loan allocations based on risks of default, financial instability, or fraudulent behavior.

Although FIG. 7 illustrates an example process 700, In some embodiments, process 700 may include additional steps, fewer steps, different steps, or steps arranged in a different order than depicted. Additionally, two or more steps may be performed in parallel.

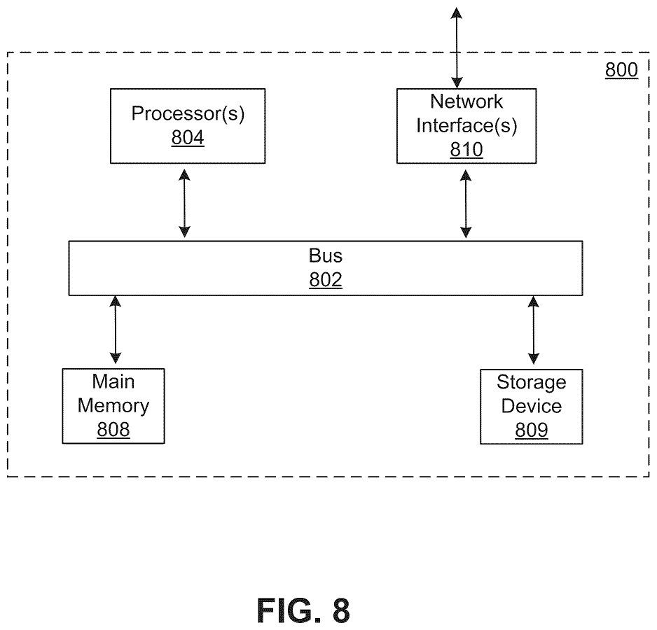

FIG. 8 illustrates an example computing device in which any of the embodiments described herein may be implemented. The computing device may be used to implement one or more components of the systems and the methods shown in FIGS. 1-7. The computing device 800 may comprise a bus 802 or other communication mechanisms for communicating information and one or more hardware processors 804 coupled with bus 802 for processing information. Hardware processor(s) 804 may be, for example, one or more general-purpose microprocessors.

The computing device 800 may also include a main memory 808, such as a random-access memory (RAM), cache, and/or other dynamic storage devices, coupled to bus 802 for storing information and instructions to be executed by processor(s) 804. Main memory 808 also may be used for storing provisional variables or other intermediate information during the execution of instructions to be executed by processor(s) 804. Such instructions, when stored in storage media accessible to processor(s) 804, may render computing device 800 into a special-purpose machine that is customized to perform the operations specified in the instructions. Main memory 808 may include non-volatile media and/or volatile media. Non-volatile media may include, for example, optical or magnetic disks. Volatile media may include dynamic memory. Common forms of media may include, for example, a floppy disk, a flexible disk, hard disk, solid-state drive, magnetic tape, or any other magnetic data storage medium, a CD-ROM, any other optical data storage medium, any physical medium with patterns of holes, a RAM, a DRAM, a PROM, and EPROM, a FLASH-EPROM, NVRAM, any other memory chip or cartridge, or networked versions of the same.

The computing device 800 may implement the techniques described herein using customized hard-wired logic, one or more ASICs or FPGAs, firmware and/or program logic which in combination with the computing device may cause or program computing device 800 to be a special-purpose machine. According to one embodiment, the techniques herein are performed by computing device 800 in response to processor(s) 804 executing one or more sequences of one or more instructions contained in main memory 808. Such instructions may be read into main memory 808 from another storage medium, such as storage device 809. Execution of the sequences of instructions contained in main memory 808 may cause processor(s) 804 to perform the process steps described herein. For example, the processes/methods disclosed herein may be implemented by computer program instructions stored in main memory 808. When these instructions are executed by processor(s) 804, they may perform the steps as shown in corresponding figures and described above. In alternative embodiments, hard-wired circuitry may be used in place of or in combination with software instructions.

The computing device 800 also includes a communication interface 810 coupled to bus 802. Communication interface 810 may provide a two-way data communication coupling to one or more network links that are connected to one or more networks. As another example, communication interface 810 may be a local area network (LAN) card to provide a data communication connection to a compatible LAN (or WAN component to communicate with a WAN). Wireless links may also be implemented.

Certain operations may be performed in a distributed manner among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Each process, method, and algorithm described in the preceding sections may be embodied in, and fully or partially automated by, code modules executed by one or more computer systems or computer processors comprising computer hardware. The processes and algorithms may be implemented partially or wholly in application-specific circuitry.

When the functions disclosed herein are implemented in the form of software functional units and sold or used as independent products, they can be stored in a processor-executable non-volatile computer-readable storage medium. Particular technical solutions disclosed herein (in whole or in part) or aspects that contribute to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, wherein the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain method or process blocks may be omitted In some embodiments. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of exemplary methods described herein may be performed, at least partially, by an algorithm. The algorithm may be composed in program codes or instructions stored in a memory (e.g., a non-transitory computer-readable storage medium described above). Such an algorithm may comprise a machine learning algorithm. In some embodiments, a machine learning algorithm may not explicitly program computers to perform a function but can learn from training data to make a prediction model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

Certain of the operations may be performed in a distributed manner among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is in fact disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The terms “include” or “comprise” are used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. A computer-implemented method, comprising:
receiving a resource request from a user for a resource hosting device to allocate resource, wherein the resource request comprises a plurality of data inputs from a plurality of data sources, and each data source comprises one type of user features of the user requesting the resource;
feeding the plurality of data inputs to a first set of machine learning models to generate a set of first risk scores, wherein each machine learning model in the first set of machine learning models is trained on the user features from a single data source, and generates a first risk score based on the data input from the single data source;
feeding the plurality of data inputs to a second machine learning model to generate a second risk score, wherein:
the second model is a decision tree-based model that are trained on multiple types of user features to learn missing feature patterns across the plurality of data sources, thereby handling cases where one or more types of user features are incomplete or missing from the plurality of data inputs,
the second model generates the second risk score based on feature dependencies in the plurality of data inputs, and
in response to one or more the plurality of data inputs being incomplete or missing, the second model generates the second risk score based on the feature dependencies in the plurality of data inputs and the learned missing feature patterns;
ensembling the set of first risk scores and the second risk score to generate an ensembled risk score; and
transmitting the ensembled risk score to the resource hosting device causing the resource hosting device to respond to the resource allocation request based on the ensembled risk score.

2. The computer-implemented method of claim 1, wherein the second model comprises a plurality of decision trees, and
in response to one or more the plurality of data inputs being incomplete or missing, the second model generates the second risk score by dynamically adjusting prediction pathways in the decision trees for the one or more incomplete or missing data inputs based on the learned missing feature patterns.

3. The computer-implemented method of claim 1, wherein the first set of machine learning models are respectively corresponding to the plurality of data sources, and
each machine learning model in the first set of machine learning models comprises a logistic regression model that is trained on the user features from the corresponding data source.

4. The computer-implemented method of claim 3, wherein:
in response to the data input from one of the plurality of data sources is incomplete or empty, deactivating the logistic regression model corresponding to the data source.

5. The computer-implemented method of claim 1, wherein the second model comprises a LightGBM model.

6. The computer-implemented method of claim 1, wherein to process the incomplete or missing data input, the training of the second model comprises:
assigning incomplete or missing user features with a separate splitting category during tree construction, thereby allowing the second model to learn a default direction for instances with null or non-available inputs; and
updating the default direction at each training iteration, based on loss-reduction criteria observed in a training set comprising both complete and incomplete user features.

7. The computer-implemented method of claim 1, wherein the processing incomplete or missing data input comprises:
applying a dynamically generated split threshold for each type of user features such that, when a type of user features is unavailable for a given request, the second model automatically routes the given request to a best-fit child node of a decision tree determined by historical patterns of missing data.

8. The computer-implemented of claim 1, wherein the ensembling comprises:
normalizing the set of first risk scores and the second risk score into normalized scores on a common scale,
combining the normalized scores by applying confidence-based weights to generate a combined score, where the weight for each normalized score is adjusted according to a predictive confidence of a corresponding machine learning model, and
generating the ensembled risk score by transforming the combined score into a probability format.

9. The computer-implemented method of claim 8, wherein the predictive confidence of the corresponding machine learning model is generated based on model performance metrics including Gini coefficients or area under the curve (AUC) scores.

10. The computer-implemented method of claim 8, wherein the predictive confidence of each machine learning model is adjusted in real-time based on real-time performance monitoring.

11. The computer-implemented method of claim 8, wherein the normalizing the set of first risk scores and the second risk score comprises:
converting each of the set of first risk scores and the second risk score using a logit function; and
calibrating log-odds values using a scaling function.

12. The computer-implemented method of claim 1, wherein the response to the resource allocation request comprises:
in response to the ensembled risk score being greater than a first threshold:
rejecting the resource allocation request; and
sending an alert requesting for additional data.

13. The computer-implemented method of claim 1, wherein the response to the resource allocation request comprises:
in response to the ensembled risk score being greater than a second threshold:
identifying the resource allocation request as a malicious request;
determining a source address associated with the malicious request in real time, wherein the source address comprises a user account identifier, a device identifier, an IP address, or a user identifier;
rejecting the malicious request in real time; and
blocking future requests from the source address.

14. The computer-implemented method of claim 1, wherein the response to the resource allocation request comprises:
in response to the ensembled risk score below a first threshold, allocating resources requested by the resource allocation request.

15. The computer-implemented method of claim 1, wherein:
the resource comprises cloud computing resources, and
the resource hosting device comprises a cloud-based infrastructure configured to allocate virtual machine instances, GPU resources, or other computing resources based on the ensembled risk score,
wherein the resource hosting device denies, approves, or modifies the requested compute allocation in response to the ensembled risk score indicating a risk of malicious activity, excessive resource consumption, or inefficient utilization.

16. The computer-implemented method of claim 1, wherein:
the resource comprises network bandwidth, and
the resource hosting device comprises a network infrastructure system configured to allocate reserved bandwidth for data transfers or video streaming based on the ensembled risk score,
wherein the resource hosting device approves, denies, or adjusts an allocation of the requested network bandwidth in response to the ensembled risk score indicating a risk of fraudulent activity, excessive resource hoarding, or inefficient utilization.

17. The computer-implemented method of claim 1, wherein:
the resource comprises Artificial Intelligence (AI) model instances, and
the resource hosting device comprises an AI infrastructure system configured to allocate computing resources for deploying, fine-tuning, or executing AI model instances based on the ensembled risk score,
wherein the resource hosting device approves, denies, or modifies an allocation of the requested AI model instances in response to the ensembled risk score indicating a risk of malicious activity, excessive resource consumption, unauthorized usage, or inefficient allocation.

18. The computer-implemented method of claim 1, wherein:
the resource comprises loan funds, and
the resource hosting device comprises a loan management system configured to allocate loan amounts to the user based on the ensembled risk score,
wherein the resource hosting device approves, denies, or adjusts an allocation of the requested loan amount in response to the ensembled risk score indicating a risk of credit default, financial instability, or fraudulent activity.

19. A system, comprising one or more processors and one or more non-transitory computer-readable memories coupled to the one or more processors and configured with instructions executable by the one or more processors to cause the system to perform operations comprising:
receiving a resource request from a user for a resource hosting device to allocate resource, wherein the resource request comprises a plurality of data inputs from a plurality of data sources, and each data source comprises one type of user features of the user requesting the resource;
feeding the plurality of data inputs to a first set of machine learning models to generate a set of first risk scores, wherein each machine learning model in the first set of machine learning models is trained on the user features from a single data source, and generates a first risk score based on the data input from the single data source;
feeding the plurality of data inputs to a second machine learning model to generate a second risk score, wherein:
the second model is a decision tree-based model that are trained on multiple types of user features to learn missing feature patterns across the plurality of data sources, thereby handling cases where one or more types of user features are incomplete or missing from the plurality of data inputs,
the second model generates the second risk score based on feature dependencies in the plurality of data inputs, and
in response to one or more the plurality of data inputs being incomplete or missing, the second model generates the second risk score based on the feature dependencies in the plurality of data inputs and the learned missing feature patterns;
ensembling the set of first risk scores and the second risk score to generate an ensembled risk score; and
transmitting the ensembled risk score to the resource hosting device causing the resource hosting device to respond to the resource allocation request based on the ensembled risk score.

20. A non-transitory computer-readable storage medium configured with instructions executable by one or more processors to cause the one or more processors to perform operations comprising:
receiving a resource request from a user for a resource hosting device to allocate resource, wherein the resource request comprises a plurality of data inputs from a plurality of data sources, and each data source comprises one type of user features of the user requesting the resource;
feeding the plurality of data inputs to a first set of machine learning models to generate a set of first risk scores, wherein each machine learning model in the first set of machine learning models is trained on the user features from a single data source, and generates a first risk score based on the data input from the single data source;
feeding the plurality of data inputs to a second machine learning model to generate a second risk score, wherein:
the second model is a decision tree-based model that are trained on multiple types of user features to learn missing feature patterns across the plurality of data sources, thereby handling cases where one or more types of user features are incomplete or missing from the plurality of data inputs,
the second model generates the second risk score based on feature dependencies in the plurality of data inputs, and
in response to one or more the plurality of data inputs being incomplete or missing, the second model generates the second risk score based on the feature dependencies in the plurality of data inputs and the learned missing feature patterns;
ensembling the set of first risk scores and the second risk score to generate an ensembled risk score; and
transmitting the ensembled risk score to the resource hosting device causing the resource hosting device to respond to the resource allocation request based on the ensembled risk score.
